(19) United States
(12) Patent Application Publication
(10) Pub. No.: US 2017/0297208 A1
(43) Pub. Date: Oct. 19, 2017

(54) DIE TRANSPORT DEVICE AND METHOD

(71) Applicants: Dan Sherwood, Cleveland, OH (US); Craig Hayward, Cleveland, OH (US)

(72) Inventors: Dan Sherwood, Cleveland, OH (US); Craig Hayward, Cleveland, OH (US)

(21) Appl. No.: 15/487,618

(22) Filed: Apr. 14, 2017

Related U.S. Application Data
(60) Provisional application No. 62/323,207, filed on Apr. 15, 2016.

(51) Int. Cl. B25J 15/06; B25J 15/00

(52) U.S. Cl. CPC B25J 15/0616; B25J 15/0608; B25J 15/0014; B25J 15/008

(57) ABSTRACT

Provided is a die lift system comprising an end effector capable of lifting and manipulating a die, creating a safe and efficient way to do so free off all physical exertion by the worker associated with the lifting and maneuvering of the die; the end effector having the ability to engage a die; the end effector having at least one series of tines capable of grasping the die; the end effector having the ability to be securely coupled to the die; and the end effector having the ability to disengage from the die.

This application claims priority to U.S. Provisional Patent App. No.: 62/323,207, filed Apr. 15, 2016, the contents of which are incorporated herein by reference.

### TECHNICAL FIELD

This invention relates generally to the ability to safely and efficiently exchange dies from large press machines. In particular, this invention eliminates the need for workers to physically handle the die, eliminating the possibility of workers being injured through the handling of heavy dies in association with their exchange in a punch press.

### BACKGROUND

Dies are used for various applications in association with a punch press machine. The dies are normally comprised of two independent blocks or steel, or another suitable metal or material, that are placed together within the punch press. The contour of the adjacent edges of each die are such that they form the mold for the product to be produced by the punch press. Many dies to be used in conjunction with a punch press have tapered side rails located on either side. These side rails are located opposite each, running perpendicular to that of the contoured edge of the die. The side rails help to secure the die in place within the punch press.

Many dies are interchangeable for use in a variety of machines. It is common practice for a manufacturer to have a number of different dies, varying in shape and size of their contoured edges. Dies are frequently removed from the punch press as many processes require the use of multiple dies. The ability to quickly and safely remove dies from a punch press increases the amount of time that can be spent actively using the punch press. The placing of the die in the punch press is of equal importance to that of the removal.

Most dies to be used in a punch press are heavy blocks of metal weighing hundreds of pounds. Many punch presses require that the worker manually exchange the die from the press. Such work is not only time consuming, but endangers the safety of every worker that is required to lift such heavy dies. A system is needed that can efficiently exchange dies from a punch press, while also preserving the safety of the worker.

Efforts have been made to limit the amount of physical lifting associated with the changing of dies. However, nothing to date has been able to completely eliminate the worker from having to lift, carry, or secure the die at some point in the process. The problem is not sufficiently solved by decreasing the amount of time or number of occasions that a worker must lift, carry or secure a die. The ability to safely place a die in a press, or remove a die therefrom, has not been adequately addressed. Workers must subject themselves to the risk of pinching their fingers inside the press when exchanging the dies, or injuring their backs while attempting to lift or carry these heavy dies. A device that is able to substantially isolate the worker from physical harm associated with the die is proposed.

### SUMMARY

Provided is a die lift system that is used to lift and manipulate dies that are associated with a punch press. The lift system is able to secure and carry said die from one location to another, free from any physical involvement of the worker. Such movement could include lifting the die from a storage area and placing it on a punch press. Another such movement could be lifting the die out of a punch press and placing it in a storage area.

The die lift system consists of an end effector that is attached to the end of a robotic arm. The end effector has two spaced tines that extend outward. The tines are of a design that they are able to slide into the tapered side rails located on the die. In addition to the tines is a means for coupling the end effector securely to the die. Such an adhesion allows for the lift system to freely manipulate the die. When the die is securely coupled to the end effector, it is able to be safely carried about the plant. Upon the die arriving at a desired location, the end effector contains the means to disengage the die from the lift system. After the die has been disengaged, the lift system is immediately ready to perform the next required task.

### DESCRIPTION OF THE DRAWINGS

FIG. 1 is a view of the die transport device and die storage system;

FIG. 2 is a view of the end effector coupled to a die;

FIG. 3 is the reverse side of the view shown in FIG. 2, showing a means for coupling the die to, and disengaging the die from, the end effector.

### DETAILED DESCRIPTION

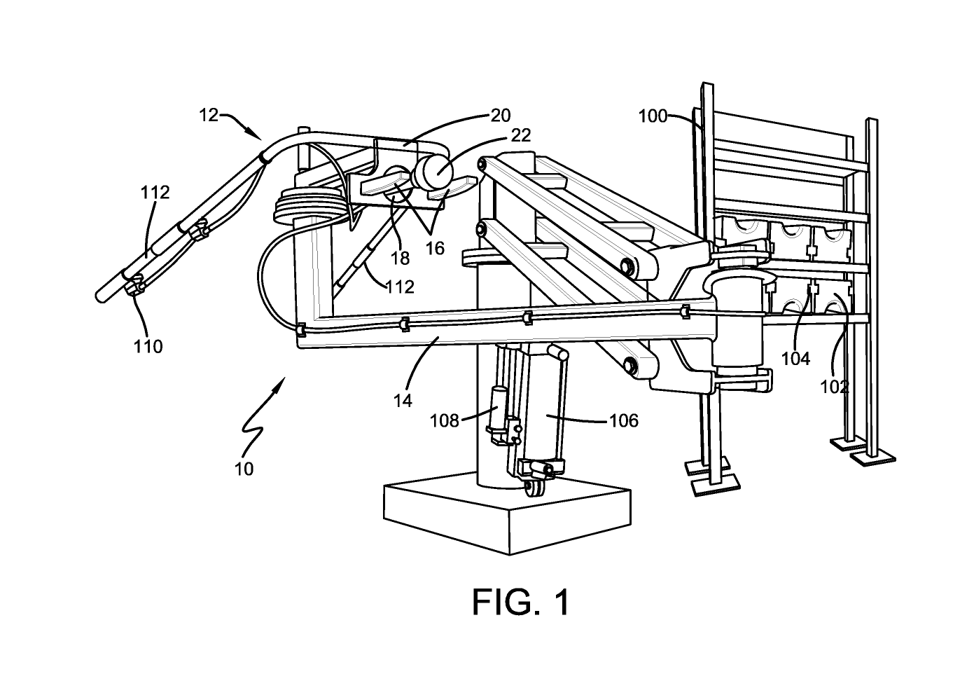

With reference to FIG. 1, a die transport device consisting of a die lift system 10 and a storage system 100. The die lift system 10 can contain an end effector 12. By way of one example, the end effector 12 may be attached to the end of a robotic arm 14. The robotic arm 14 may be one that is able to move vertically, horizontally, or in any combination of directions by way of joints and swivels. The direction and operation of the robotic arm 14 can be modified according to the desired application and use of the die lift system 10. The robotic arm 14 may have any number of pivot points associated with it so as to allow for increased movement. Any robotic arm that is capable of utilizing end effector 12 is suitable for use with the die lift system 10. The end effector 12 may be attached to the robotic arm 14 in such a way that allows the end effector 12 to rotate in any number of directions. The end effector 12 may be attached to the robotic arm 14 in any manner that allows the end effector 12 to engage a die 102. Movement of the robotic arm 14 can be accomplished manually, or through the use of a hydraulic system 106 including one or more hydraulic cylinders 108 in serial connection with a hydraulic motor and a power source. According to one embodiment, the hydraulic system 106 can be controlled by a control box 110 attached to one of a pair of handles 112 of the die lift system 10. Handles 112 can also function to allow the operator of the die lift system 10 to control movement of the robotic arm 14 and subsequently die 102 to properly position the die 102 in the desired location.

With continued reference to FIG. 1, according to one embodiment, the end effector 12 is attached to a device other than a robotic arm. The end effector 12 may be attached to a lift truck, a crane, or any other device that is capable of supporting a die 102 for transportation. By way of one example, the end effector 12 is attached to an overhead crane system. The overhead crane system can manipulate the end effector 12 so as to attach to the die. The overhead crane system is then able to raise or lower the die 102 to any desired height, free from having to personally lift the die and risk the safety of a worker.

With continued reference to FIG. 1, according to one embodiment, the end effector 12 is able to adjust to any height that the die 102 may be located. By way of one example, the robotic arm 14 is able to pivot and adjust itself so as to allow the end effector 12 to be located at a height equivalent to that of the die 102. Such a height could be located on the ground floor, or elevated to a distance above that of the base of the robotic arm 14.

With continued reference to FIG. 1, the end effector 12 contains a series of spaced tines 16. The tines 16 are spaced such that they are able to fit around the edge of a die. The tines 16 may be attached in such a way as to have the ability to adjust together either vertically, horizontally, or both. Such an attachment of the tines 16 allows for the end effector 12 to be adapted for a die 102 placed in any number of positions. Such a position could include the die 102 being placed in a punch press, the die 102 being stored at a location within the plant, such as on a rack as part of the die storage system 100, or any other position that the die 102 is in at the time it is required to be moved.

With continued reference to FIG. 1, according to one embodiment, the end effector 12 can have attached to it a series of tines. The series of tines may include multiple tines oriented in the same direction so as to embrace the die at multiple level. By way of one example, the end effector can have a series of tines stacked vertically so as to engage the die at multiple heights. By way of another example, the end effector 12 can have at least two sets of tines running perpendicular to each other so as to embrace the die on all four sides. By way of one such example, the tines can be of equal spacing so as to embrace a square die. By way of another example, the at least two sets of tines can be of differing spacing so as to embrace dies of any geometric shape.

With continued reference to FIG. 1, according to one embodiment, the tines 16 can be spaced such that they are able to fit into the tapered side rails 104 of the die 102. Such rails are present on a die so as to allow it to fit firmly into the punch press. The tines 16 can be firmly set into the tapered side rails 104 so as to increase the stability of the die 102 during transport.

According to one embodiment, the tines 16 can be set at a fixed distance apart from each other. The distance between the tines 16 can correspond to that of the width of the die 102. By way of another example, the tines 16 can be adjusted laterally so as to vary the distance between them. Such a variable width can be locked in place so as to securely affix to the die 102. By way of another example, the tines 16 can adjust independently in a vertical position so as to accommodate a wide variety of die configurations. Such vertical movement can allow for one of the tines 16 to be moved in the opposite direction of the other, or for the tines 16 to be moved in unison so as to remain at a fixed width.

With continued reference to FIG. 1, according to one embodiment, the tines 16 can bend at a specified distance away from the end effector 12. Such movement can allow for the tines 16 to be placed more securely around the die 102. Such a bending movement can occur in either a horizontal or vertical direction, or both.

With continued reference to FIG. 1, according to one embodiment, the tines 16 are made of steel. Any substance that is suitable for use in transporting a die 102 as determined by those skilled in the art is sufficient. By way of one example, the tines 16 may be made of a hard plastic compound that is capable of supporting the weight of the die 102. By way of another example, the tines 16 have a material that acts as a padding or buffer between the tines 16 and the die 102. Such a material may be rubber, a type of foam material, or any other substance that can act to limit or eliminate the scratching of the die 102 when in contact with the tines 16.

With continued reference to FIG. 1, the end effector 12 can contain a cutout 18 that may be used to aid a means for coupling the die to the end effector 12. The cutout 18, when utilized in conjunction with a coupling device, can prevent or otherwise inhibit the die 102 from moving about within the end effector 12 during transport. By way of one example, a cutout 18 can be made on the face 20 of the end effector 12 at a location between the tines that supports the die 102. By way of another example, the cutout 18 can be made on the face 20 at a location not between the tines 16. By way of one example, the cutout can be a circle. By way of another example, the cutout can be any shape that allows for the coupling of the face 20 of the end effector 12 and the die 102.

With continued reference to FIG. 1, according to one embodiment, the cutout 18 can be located on the face 20 of the end effector 12 and allow for the use of an air magnet as a means of coupling the die 102 to the end effector 12. Such an air magnet may be any type of device that acts to create a suction or vacuum type seal between two surfaces. By one of one example, a valve can be inserted into the cutout 18 of the face 20 that creates an air tight suction seal between the face 20 and the die 102. Such an air magnet may be attached to the end effector 12. By way of another example, the air magnet can be a separate device that can be manually attached to the end effector 12. By way of another example, a series of air magnets can be used to as to couple the die 102 to the face 20. When the air magnet or air magnets are released from the end effector 12 the die 102 can be released from the face 20.

With continued reference to FIG. 1, according to one embodiment, an adhesive can be attached to the face 20 of the end effector 12. Such an adhesive may be of any material that is able to support the weight of a die, as known by those skilled in the art. The adhesive may be reusable so as to be left on the face 20 for a series of consecutive uses. By way of another example, the adhesive must be replaced after every use so as to ensure that it is capable of securing the die to the face 20.

According to one embodiment, an electromagnet can be attached to the face 20 of the end effector 12. The electromagnet should be of sufficient strength to create a bond capable of holding the die 102 in place during transport. By way of one example, a series of electromagnets can be attached to the face 20 of the end effector 12. The electromagnets can be equipped with a release mechanism so as to release their hold of the die 102 at the command of the operator. By way of one example, the release mechanism creates an obstruction between the electromagnet and the die 102. By way of another example, the release mechanism can interrupt the electromagnet so as to cease its coupling to the die 102. Any means for disengaging the pull of the electromagnet by those deemed skilled in the art may be used.

With continued reference to FIG. 1, a push arm 22 can be attached to the end effector 12. According to one embodiment, the push arm 22 can act to fully disengage the die 102 from the end effector 12. The push arm 22 may be made of such a material so as to adequately perform such a purpose. By way of one example, the push arm 22 can be made from steel. By way of another example, the push arm 22 can be made of a hard plastic compound, or any other material capable of disengaging the die 102 from the end effector 12.

With continued reference to FIG. 1, according to one embodiment, the push arm 22 is located just beneath the tines 16. The push arm 22 may be circular, rectangular, or any other shape that can fully disengage the die from the end effector 12 as determined by those skilled in the art. By way of one example, the push arm 22 can be encased so as to be allowed to slide freely. The encasement may be in the same shape as the push arm 22, or any other shape that is capable of allowing the push arm 22 to pass through it.

According to one embodiment, the push arm 22 can be of a uniform shape and size. By way of another example, the push arm 22 can have an end that can allow for a better contacting of the die 102. Such an affixed end may be in a shape other than that of the body of the push arm 22. By way of another example, the contacting portion of the push arm 22 is of the same shape as the body of the push arm 22, but increased in size so as to allow the push arm 22 to better disengage the die 102. The geometry of the push arm 22 may take the form of any different number of shapes that will allow for the push arm 22 to serve the intended purpose of disengaging the die 102.

According to one embodiment, the push arm 22 can be operated by purely mechanical means and involves no additional parts. By way of one example, the push arm 22 can be put into use by the operator sliding the push arm 22 through the encasement so as to release the die 102. By way of another example, the push arm 22 is operated by electronic, hydraulic, or any other means capable of activating the push arm 22. When the push arm 22 is activated, it can slide through the encasement so as to disengage the die 102 from the end effector 12. According to one embodiment, the push arm 22 can for part of the hydraulic system 106 and can include a hydraulic piston powered by the same hydraulic motor that powers the hydraulic system 106. Further, control of the push arm 22 can be integrated into the control box 110 for ease of operation.

With continued reference to FIG. 1, according to one embodiment, the push arm 22 can include dual- or multi-functionality. By way of one example, the push arm 22 can include the contact face of an electro magnet for securing the die 102 in the end effector 12. Alternatively, the push arm 22 can include the contact face of an air magnet. The push arm 22 can include an adhesive face for contacting the die 102. Further, the push arm 22 can incorporate one or more of these along with the function of pushing the die 102 free from the end effector 12.

With continued reference to FIG. 1, according to one embodiment, the push arm 22 is not enclosed in any type of casing. The push arm 22 can be attached to a portion of the end effector 12 that allows it to directly contact a portion of the die 102. Such direct contact with the die 102 may be achieved through a cutout 18 on the face 20 that is in contact with the die 102, or through any other means that allows for this act to be accomplished.

With continued reference to FIG. 1, according to one embodiment, the push arm 22 can be located in a position other than beneath the tines 16 of the end effector 12. Such a position may be above the tines 16, offset to either side of the tines 16, or any other location on the end effector 12 that allows for the push arm 22 to disengage the die 102 from the end effector 12.

With continued reference to FIG. 1, according to one embodiment, the push arm 22 is not connected directly to the end effector 12. The push arm 22 may be attached to the robotic arm 14 or any other surface that allows for the push arm 22 to perform a function that acts to disengage the die 102 from the end effector 12. By way of one example, the push arm 22 can be mounted to a surface of the robotic arm 14 that is independent from the end effector 12, but is positioned such that it is able to contact the die 102 when the end effector 12 is mounted to the robotic arm 14.

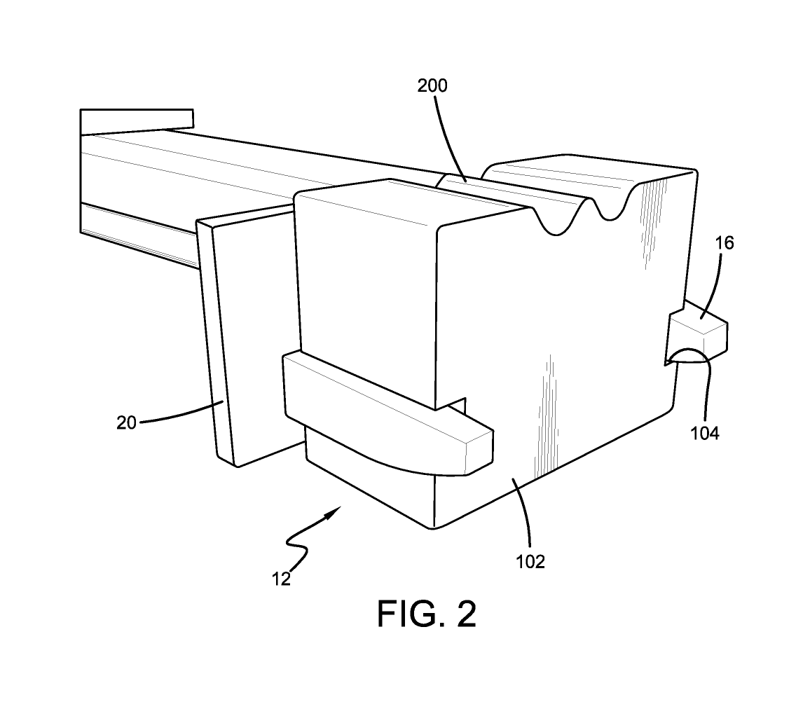

With reference to FIG. 2, the die lift system 10 contains an end effector 12 that is used to manipulate a die 102. The die 102 is grasped by a series of tines 16. The tines 16 are placed on two opposing surfaces of the die 102. The tines 16 are capable of being inserted into the tapered side rails 104 located on the die 102.

With continued reference to FIG. 2, according to one embodiment, the tines 16 are capable of being inserted directly into the tapered side rails 104. By way of one example, the tines 16 can be of a length that allows the tines 16 to extend to a length beyond that of the die 102. By way of another example, the tines 16 can be of a length that results in the tines 16 being flush with the face of the die 102. The tines 16 are capable of being any length that allows for the die 102 to be constrained as chosen by those skilled in the art.

With continued reference to FIG. 2, according to one embodiment, the tines 16 are of a uniform width extending from the end effector 12. By way of one example, the tines 16 can vary by increasing in width as they extend outward from the base of the end effector 12. By way of another example, the tines 16 can decrease in width as they extend outward from the end effector 12. The tines 16 may be of any uniform or varying width that allows for the insertion of the tines 16 into the tapered side rails 104 of the die 102.

With continued reference to FIG. 2, according to one embodiment, the end effector 12 can hold the die 102 in such a position that the contoured edge 200 that is to be used for molding or other purposes is facing in an upward direction. By way of one example, the end effector 12 can hold the die 102 in such a position that the contoured edge 200 that is to be used for molding or other purposes is facing in a downward direction. The die 102 may be constrained by the tines 16 so that the contoured edge 200 of the die 102 is facing in any direction that will not result in damage to the die 102.

With continued reference to FIG. 2, the end effector 12 can contain a flat face 20. The face 20 supplies a base to which the tines 16 are attached. When the die 102 is within the grasp of the tines 16, the face 20 can be flush with one surface of the die 102. The face 20 may be of a size smaller than, equal to, or larger than that of the die 102. The face 20 may also be of a different shape than the face of the die 102.

With continued reference to FIG. 2, according to one embodiment, the face 20 does not come into direct contact with the die 102. The die 102 is held by the tines 16 at a distance away from that of the face 20. By way of one example, the tines 16 are only partially inserted into the die 102, resulting in a gap between the back side of the die 102 and the face 20.

With continued reference to FIG. 2, according to one embodiment, the tines 16 are not inserted into the tapered side rails 104. The tines 16 are placed flush against opposing sides of the die 102. By way of one example, the tines 16 are of such a width that they are able to firmly grasp the die 102 in such a manner that allows for the die 102 to not slide about. The die 102 may be held in place by the force exerted by the tines 16 against the die 102, or by any other means suitable for holding the die 102 in place as chosen by those of skill in the art.

With continued reference to FIG. 2, according to one embodiment, the tines 16 can have a device on the end that is capable of locking the die 102 in place. By way of one example, the device can be a locking mechanism that is placed over top of the tines 16. The device may lay on top of the tines 16, physically attach to or interlock with the tines 16, or be affixed to the tines 16 in any manner that allows for the device to limit the ability of the die 102 to be freed from the tines 16. By way of another example, the tines 16 can be capable of bending or flexing in differing directions. The end of the tines 16 that protrude beyond the face of the die 102 are altered in such a manner as to lock the die 102 in place. This may be accomplished by constructing the tines 16 out of a material capable of such movement, through adding an extension to the end of each of the tines 16, or any other means available to those skilled in the art to allow the edge of the tines 16 to keep the die 102 locked in place.

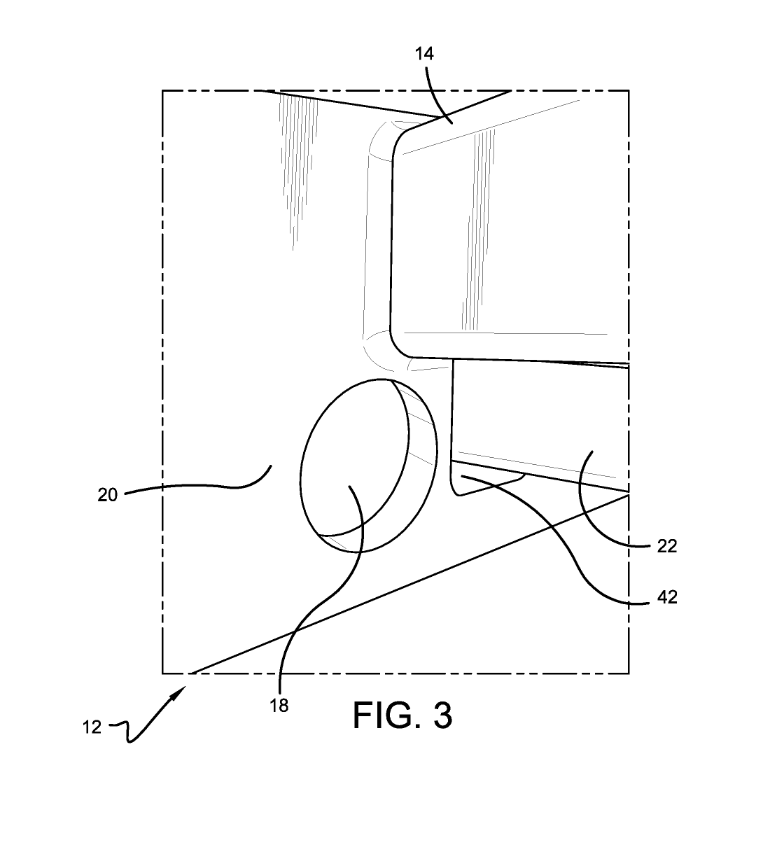

With reference to FIG. 3, a cutout 18 is made on the face 20 of the end effector 12. The cutout 18 gives the end effector 12 the means to be coupled to a die 102. By way of one example, the coupling means is a circular cutout. The circular cutout 18 may allow for the use of an external device to act as a coupling agent between the back side of the die 102 and the end effector 12. An external device may be an air magnet that creates a suction seal between the die and the end effector 12, a device containing an electromagnet, or any other means capable of securing the die 102 to the end effector 12 as deemed suitable by those skilled in the art.

With continued reference to FIG. 3, according to one embodiment, the cutout 18 can be a square, rectangular, or any other geometric shape capable of supporting a coupling device that can be used to secure the die 102 to the end effector 12. By way of one example, the cutout is not fully extruded through the entire face 20. Rather, the cutout 18 is located at such a position along one of the edges of the face 20 that the cutout 18 uses one of said edges of the face 20 as a side of the cutout 18. By way of another example, the cutout 18 is located in a corner of the face 20 that results in the cutout 18 using two of the edges of the face 20 as sides of the cutout 18.

With continued reference to FIG. 3, according to one embodiment, there is no cutout on the face 20. A means for coupling the die 102 to the face 20 of the end effector 12 is used that does not require such a feature. By way of one example, the coupling device attaches to the face 20 and the die 102 by way of a clamping device. By way of another example, the coupling means involves an electromagnetic device that attaches directly to the face 20. The electromagnet is able to directly contact the die 102 in order to couple the die to the face 20. An adhesive surface or any other means of coupling the die 102 to the face 20 deemed suitable by those skilled in the art may be used.

With continued reference to FIG. 3, the end effector 12 may be attached to the robotic arm 14 by way of welding. By way of other examples, the end effector 12 may be attached to the robotic arm 14 through a series of clamps, through interchangeable devices compatible with the robotic arm, or any other means capable of securing the end effector 12 to the robotic arm 14 as deemed suitable by those skilled in the art.

With continued reference to FIG. 3, the push arm 22 can slide through an opening 300 in the face 20, separate from cutout 18, which can allow the push arm 22 to directly contact the die 102. The push arm 22 may be of any size that is smaller than that of the opening 300, so as to allow the push arm 22 to freely move through the opening 300. By way of one example, the push arm 22 can controlled directly by the operator. By way of another example, the push arm is operated by an external force, such as electronics, hydraulics, or any other means capable of operating such a device as viewed by those skilled in the art.

Although described in connection with lifting dies, the lift system of the present disclosure can be easily adapted by a person of skill for use with other heavy objects and machine parts that need to be lifted and moved between locations.

Having thus described the invention, it is now claimed:

I claim:

1. A die lift system comprising:
an end effector capable of engaging a die;
at least one pair of tines configured to engage a die;
a means for coupling the die to said end effector; and
a push arm capable of disengaging the die from the end effector;
wherein the end effector is able to manipulate the location of a die.

2. The die lift system of claim 1 further comprising a robotic arm.

3. The die lift system of claim 1 wherein the at least one pair of tines are set at a fixed width.

4. The die lift system of claim 3 wherein the width between the tines is fixed corresponding to the width of tapered side rails of a die.

5. The die lift system of claim 1 wherein the width between the tines is adjustable.

6. The die lift system of claim 1 wherein the means for coupling the die to the end effector is by way of an air magnet.

7. The die lift system of claim 6 wherein the air magnet contacts the die through a cutout portion of the end effector.

8. The die lift system of claim 7 wherein the push arm directly contacts a face of the die.

9. A method for transporting a die between locations without requiring a worker to physically touch the die comprising the steps of:
a. Providing a die lift system comprising:
an end effector capable of engaging a die;
at least one pair of tines configured to engage a die;
a means for coupling the die to said end effector; and
a push arm capable of disengaging the die from the end effector;
b. engaging a die with the tines;
c. coupling the die to the end effector;
d. utilizing the end effector to manipulate the die to a new location;
e. removing the coupling means from the die; and
f using the push arm to disengage the die from the end effector.

10. The method of claim 10 wherein the die lift system further comprises a robotic arm.

11. The method of claim 10 wherein the tines are inserted into tapered side rails of a die.

12. The method of claim 10 wherein the die is coupled to the end effector by an air magnet.
